(19) United States
(12) Patent Application Publication
(10) Pub. No.: US 2005/0151456 A1
(43) Pub. Date: Jul. 14, 2005

(54) Electron-beam inspection apparatus and methods of inspecting through-holes using clustered nanotube arrays

(76) Inventors: Young-Jee Yoon, Gyeonggi-do (KR); Chung-Sam Jun, Gyeonggi-do (KR); Sang-Mun Chon, Gyeonggi-do (KR)

Correspondence Address: MYERS BIGEL SIBLEY & SAJOVEC, PO BOX 37428, RALEIGH, NC, 27627, US

(21) Appl. No.: 11/028,895

(22) Filed: Jan. 4, 2005

(30) Foreign Application Priority Data
Jan. 7, 2004 (KR) 2004-00854

(51) Int. Cl. H01J 1/02; H01J 1/14

(52) U.S. Cl. 313/311; 313/309

(57) ABSTRACT

Electron-beam generators have wide area and directional beam generation capability. The generators include anode and cathode electrodes, which are disposed in spaced-apart and opposing relationship relative to each other. A clustered carbon nanotube array is provided to support the wide area and directional beam generation. The clustered nanotube array extends between the anode and cathode electrodes. The nanotube array also has a wide area emission surface thereon, which extends opposite a primary surface of the anode electrode. The clustered nanotube array is configured so that nanotubes therein provide conductive channels for electrons, which pass from the cathode electrode to the anode electrode via the emission surface.

### REFERENCE TO PRIORITY APPLICATION

This application claims priority to Korean Application Serial No. 2004-00854, filed Jan. 7, 2004, the disclosure of which is hereby incorporated herein by reference.

### FIELD OF THE INVENTION

The present invention relates to electron-beam inspection tools used in manufacturing and, more particularly, to electron-beam inspection tools using in semiconductor wafer fabrication and methods of operating the same.

### BACKGROUND OF THE INVENTION

Various defects can occur during the fabrication of semiconductor devices and many of these defects can cause device malfunction and failure. The defects introduced during fabrication of the semiconductor devices can generally be divided into two categories including physical defects, such as particles, which can cause physical abnormalities on the surface of a semiconductor substrate, and electrical defects, which accompany physical defects but may bring about electrical failure in the semiconductor devices even in the absence of physical defects. Physical defects can generally be detected by conventional image observation equipment. However, electrical defects typically cannot be detected by such conventional observation equipment.

It is known to test contact holes (e.g., through-holes) extending to an electrically conductive region within a semiconductor substrate using an electron beam inspection apparatus. Such inspection apparatus may provide in-line monitoring to determine whether a contact hole formed in an electrically insulating layer is in an open or not-open state. If an unetched portion of material (e.g., an oxide or nitride residue) is present in the contact hole, primary electrons from the electron beam may not flow properly to the substrate for collection and may accumulate on the surface of the unetched material. If this occurs, a large quantity of secondary electrons may be emitted from the surface of the substrate. Depending on a difference in secondary electron yields, a brighter (white) or darker (black) image may be displayed for each portion of the substrate where a large amount of secondary electrons are emitted, that is, portions where unetched material is present, relative to portions where the unetched material layer is not present. By detecting these differences, physical defects may be identified. One example of an ion inspection apparatus is disclosed in commonly assigned U.S. Pat. No. 6,545,491 to Kim et al., entitled “Apparatus for detecting defects in semiconductor devices and methods of using the same.” Another example of an ion inspection apparatus is disclosed in commonly assigned U.S. Pat. No. 6,525,318 to Kim et al., entitled “Methods of Inspecting Integrated Circuit Substrates Using Electron Beams.” The disclosures of these Kim et al. patents are hereby incorporate herein by reference. One drawback of conventional electron beam inspection tools is the requirement that each contact hole on a semiconductor substrate (e.g., silicon wafer) be individually checked one-at-a-time. This one-at-a-time checking can result in long inspection times for large substrates having large quantities of contact holes. This drawback may also be present in those tools that perform inspection by evaluating wafer leakage current (e.g., electron current passing through the substrate to an electrode). However, some of these tools may use relatively large area cathode electrodes that provide wide area electron emission onto an opposing portion of an underlying substrate. This wide area emission technique may eliminate the requirement to check each contact hole one-at-a-time, but may also lead to detrimental arc discharging when high voltages are applied to the cathode electrode.

Thus, notwithstanding these conventional electron beam inspection tools, there continues to be a need for improved tools that provide high speed inspection without unwanted side effects such as arc discharging resulting from high voltage levels.

### SUMMARY OF THE INVENTION

Embodiments of the invention include electron-beam generators having wide area and directional beam generation. In some of these embodiments, anode and cathode electrodes are disposed in spaced-apart and opposing relationship relative to each other and powered by a power source. A clustered nanotube array is also provided to support the wide area and directional beam generation. The clustered nanotube array extends between the anode and cathode electrodes. The array also has a wide area emission surface thereon, which extends opposite a primary surface of the anode electrode. The clustered nanotube array is configured so that nanotubes therein provide conductive channels for electrons, which pass from the cathode electrode to the anode electrode via the emission surface. According to preferred aspects of these embodiments, the clustered nanotube array includes an array of carbon nanotubes. The embodiments may also include an electromagnetic field generator, which is configured to establish an electromagnetic field in a space between the anode and cathode electrodes.

Additional embodiments of the invention include electron-beam inspection tools. These inspection tools include anode and cathode electrodes, which are disposed in spaced-apart and opposing relationship relative to each other. The anode electrode has a primary surface thereon, which is configured to receive a semiconductor wafer. A clustered nanotube array is also provided to enhance electron-beam emission efficiency. The array extends between the anode and cathode electrodes and has an emission surface thereon, which extends opposite the primary surface of the anode electrode. The clustered nanotube array is configured so that nanotubes therein provide conductive channels for electrons passing from the cathode electrode to the anode electrode via the emission surface. An ammeter is also provided to measure leakage current passing from the semiconductor wafer to the primary surface of the anode electrode. This ammeter is electrically coupled to the anode electrode.

Still further embodiments of the invention include another electron-beam inspection tool. This tool includes anode and cathode electrodes, which are disposed in spaced-apart and opposing relationship relative to each other. The anode electrode has a primary surface thereon and an array of emission holes therein. A clustered nanotube array is also provided. The array extends between the anode and cathode electrodes. The array has an emission surface thereon that extends opposite the primary surface of the anode electrode. The clustered nanotube array is configured so that nanotubes therein provide conductive channels for electrons passing from the cathode electrode to the anode electrode via the emission surface. A power source is electrically coupled to the anode and cathode electrodes, so that an electric field can be established therebetween. A supporting stage, which is configured to receive a semiconductor wafer on a primary surface thereof, is also provided and an ammeter is electrically coupled to the stage. In these embodiments, the anode electrode is disposed between the stage and the cathode electrode, so that electrons passing through the emission holes in the anode electrode are received by the wafer.

Additional embodiments of the invention include methods of inspecting a semiconductor substrate by emitting beams of electrons from a wide area emission surface of a clustered carbon nanotube array to a semiconductor substrate having a plurality of contact holes thereon. The substrate includes a semiconductor wafer and an electrically insulating layer on the semiconductor wafer. The electrically insulating layer has the plurality of contact holes therein that expose corresponding portions of the semiconductor wafer. This emitting step is performed in a presence of an electromagnetic field, which has flux lines extending in a substantially orthogonal direction relative to the emission surface.

### BRIEF DESCRIPTION OF THE DRAWINGS

FIG. 1 is a perspective view of an electron-beam inspection apparatus according to a first embodiment of the invention.

FIG. 2 is a flow diagram of operations that illustrate methods of inspecting substrates using the apparatus of FIG. 1.

FIG. 3 is a perspective view of an electron-beam inspection apparatus according to a second embodiment of the invention.

FIG. 4 is a flow diagram of operations that illustrate methods of inspecting substrates using the apparatus of FIG. 3.

FIG. 5 is a perspective view of an electron-beam inspection apparatus according to a third embodiment of the invention.

FIG. 6 is a flow diagram of operations that illustrate methods of inspecting substrates using the apparatus of FIG. 5.

FIG. 7 is a perspective view of an electron-beam inspection apparatus according to a fourth embodiment of the invention.

FIG. 8 is a flow diagram of operations that illustrate methods of inspecting substrates using the apparatus of FIG. 7.

### DESCRIPTION OF PREFERRED EMBODIMENTS

The present invention now will be described more fully herein with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. In the drawings, the thickness of layers and regions are exaggerated for clarity of description. It will also be understood that when a layer is referred to as being “on” another layer or substrate, it can be directly on the other layer or substrate, or intervening layers may also be present. Like reference numerals refer to like elements throughout.

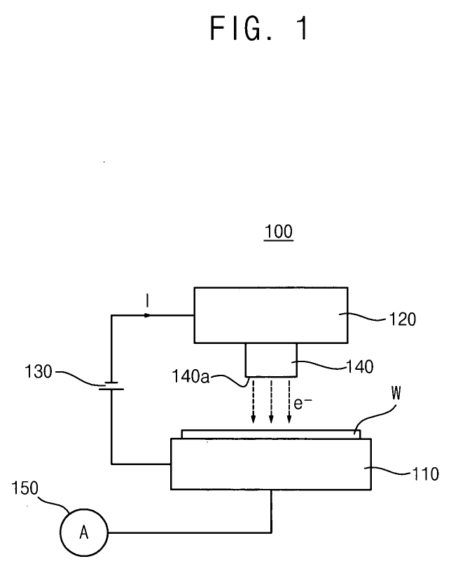

FIG. 1 illustrates an electron-beam inspection tool 100 according to a first embodiment of the invention. This tool 100 includes an anode electrode 110 and a cathode electrode 120, which are powered by a power source 130. This power source 130 establishes a sufficient voltage between the anode electrode 110 and cathode electrode 120 to thereby promote electron emission in a downward direction from the cathode electrode 120 to the anode electrode 110. The anode electrode 110 has a primary surface (e.g., upper surface) that is configured to support a semiconductor substrate. This substrate may include a semiconductor wafer (W) having an electrically insulating layer (not shown) thereon. This electrically insulating layer may have a plurality of contact holes therein that expose underlying portions of the semiconductor wafer (W). These contact holes can be inspected for the presence of residues by evaluating the magnitude of leakage current passing from a backside of the wafer (W) to the anode electrode 110. This leakage current may be measured by an ammeter 150, which is electrically coupled to the anode electrode 110.

The inspection tool 100 also includes a clustered nanotube array 140, which is mounted to an emission surface of the cathode electrode 120. The clustered nanotube array 140 has a wide area emission surface 140a thereon, which extends opposite a primary surface of the anode electrode 110. This emission surface 140a is filled with a high density of closely-spaced nanotube openings, which may have diameters in a range from about 1 nm to about 10 nm. The clustered nanotube array 140 is configured so that nanotubes therein provide conductive channels for electrons (e−), which under the influence of an electric field pass from the cathode electrode 120 to the anode electrode 110 via the emission surface 140a. The clustered nanotube array 140 may be a carbon nanotube array having carbon nanotubes therein. As understood by those skilled in the art, carbon nanotubes may have closed hexagonal honeycomb structures, which enclose cylindrical channels. Examples of carbon nanotube arrays are described in articles by: B. J. Hinds et al., entitled “Aligned Multiwalled Carbon Nanotube Membranes,” Science, Vol. 303, Jan. 2, 2004, pp. 62-64; A. Cao et al., entitled “Grapevine-like Growth of Single Walled Carbon Nanotubes Among Vertically Aligned Multiwalled Nanotube Arrays,” App. Phys. Letters, Vol. 79, No. 9, August 2001, pp. 1252-1254; and W. Hu et al., entitled “Growth of Well-Aligned Carbon Nanotube Arrays on Silicon Substrates Using Porous Alumina File as a Nanotemplate,” App. Phys. Letters, Vol. 79, No. 19, November 2001, pp. 3083-3085.

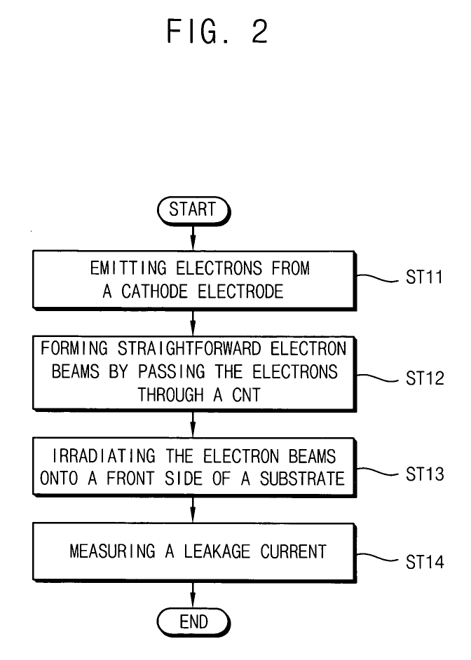

FIG. 2 is a flow diagram of operations that illustrate an inspection method performed by the apparatus of FIG. 1. These operations include emitting electrons from a cathode electrode 120, Block ST11, and forming a wide area and uniformly downward emission of these electrons from an emission surface of the nanotube array 140 by passing these electrons through carbon nanotubes within the array 140, Block ST12. This uniform emission of electrons is irradiated onto an exposed surface of a substrate, Block ST13. This substrate may include a semiconductor wafer having an electrically insulating layer thereon containing a plurality of contact holes. These contact holes may include some contact holes that are at least partially filled with insulating residues that block passage of electrons therethrough. As illustrated by Block ST14, a leakage current from the underside surface of the wafer is measured with an ammeter to identify the presence of blocked contact holes. Techniques to identify the presence of blocked holes from leakage current measurements are well known to those skilled in the art and need not be described further herein.

During operation of the inspection tool 100, the power source 130 supplies a field emission current (I) to the cathode electrode 120. The magnitude of this emission current (I) may be determined from the following Formula 1:
I=aV² exp[−(bφ^{1.5})/(βV)] (1)
where “a” and “b” are constants, V represents an applied voltage established by the power source, which extends between the anode and cathode electrodes, V represents a field enhancement factor and (p represents a work function.

This Formula 1 demonstrates that when a conventional cathode electrode having a wide emission area is used as an emission source, a very high voltage of about 10⁴V/μm may need to be established between the cathode and anode electrodes to obtain emission. Unfortunately, this high voltage may contribute to uneven emission of electrons from the cathode electrode and arc discharge or material breakdown at a surface of the cathode electrode. In contrast, the use of a clustered nanotube array 140 containing carbon nanotubes may result in electron emission at much lower voltages. For example, although a carbon nanotube array may have a work function (e.g., 4.5 eV) similar to a work function of a metal tip, the field enhancement factor β of the carbon nanotube array may be greater than about 1,000. This high field enhancement factor translates to a requirement that only a relatively small voltage of about 10V/μm is required to obtain electron emission from an emission surface 140a of the carbon nanotube array.

As described in the aforementioned articles, carbon nanotube arrays may be fabricated using a variety of techniques. These techniques include arc-discharging, laser vapor deposition, plasma-enhanced chemical vapor deposition, thermal chemical vapor deposition, vapor phase growth and other techniques. In an arc-discharging technique, a direct current is applied between a positive graphite electrode and a negative graphite electrode to generate an electron discharge. Electrons emitted from the negative graphite electrode collide against the positive graphite electrode and are converted into carbon clusters. The carbon clusters may be condensed on a surface of the negative graphite electrode, which is cooled at a very low temperature, to thereby form a carbon nanotube array. In a laser vapor deposition method, a laser is irradiated onto a graphite target in an oven to thereby evaporate the graphite target. The evaporation of the graphite target results in the condensation of carbon clusters at very low temperature. In a plasma chemical vapor deposition method, a high-frequency voltage is applied to a pair of electrodes to generate a glow discharge in a reaction chamber. Examples of reaction gases include C₂H₄, CH₄ and CO, for example. Examples of catalyst metals include Fe, Ni, Co, which may be deposited on a substrate that includes Si, SiO₂, and glass. The catalyst metal on the substrate is etched to form catalyst metal particles having nano-dimensions. The reaction gases are then introduced into the reaction chamber and a glow discharge is performed to thereby grow a carbon nanotube array on the catalyst metal particles.

A carbon nanotube array of high purity may also be manufactured using thermal chemical vapor deposition. In this technique, a catalyst metal including Fe, Ni or Co is deposited on a substrate. The substrate is then wet-etched using a hydrogen fluoride (HF) solution. The etched substrate is received in a quartz boat. The quartz boat is then loaded into a chemical vapor deposition (CVD) chamber. The catalyst metal is etched in the chamber using a NH₃ gas at a high temperature, to thereby form catalyst metal particles having nano-dimensions.

In a vapor phase growth technique, reaction gases including carbon and a catalyst metal are directly used under a vapor phase state. The catalyst metal is vaporized at a first temperature to form catalyst metal particles having nano-dimensions. The catalyst metal particles are heated at a second temperature greater than the first temperature so that carbon atoms are decomposed from the reaction gases. The carbon atoms are chemisorbed and diffused on the catalyst metal particles.

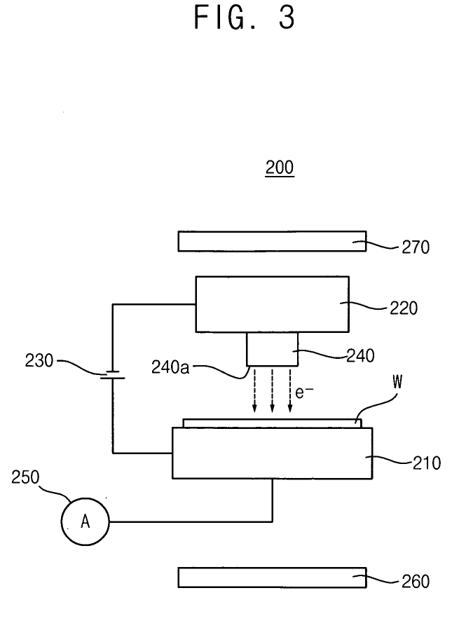

FIG. 3 illustrates an electron-beam inspection tool 200 according to a second embodiment of the invention. This tool 200 includes an anode electrode 210 and a cathode electrode 220, which are powered by a power source 230. This power source 230 establishes a sufficient voltage between the anode electrode 210 and cathode electrode 220 to thereby promote electron emission in a downward direction from the cathode electrode 220 to the anode electrode 210. The tool 200 also includes a pair of electromagnets 260 and 270 that operate together to establish a magnetic field in a space between the anode and cathode electrodes. The flux lines in the magnetic field extend vertically in a direction parallel to the electron emission path and orthogonal to an electron emission surface 240a.

The anode electrode 210 has a primary surface (e.g., upper surface) that is configured to support a semiconductor substrate. This semiconductor substrate may include a semiconductor wafer (W) having an electrically insulating layer (not shown) thereon. This electrically insulating layer may have a plurality of contact holes therein that expose underlying portions of the semiconductor wafer (W). These contact holes can be inspected for the presence of residues by evaluating the magnitude of leakage current passing from a backside of the wafer (W) to the anode electrode 210. This leakage current may be measured by an ammeter 250, which is electrically coupled to the anode electrode 210.

The inspection tool 200 also includes a clustered nanotube array 240, which is mounted to an emission surface of the cathode electrode 220. The clustered nanotube array 240 has a wide area emission surface 240a thereon, which extends opposite a primary surface of the anode electrode 210. This emission surface 240a is filled with a high density of closely-spaced nanotube openings. The clustered nanotube array 240 is configured so that nanotubes therein provide conductive channels for electrons (e−), which under the influence of an electric field pass from the cathode electrode 220 to the anode electrode 210 via the emission surface 240a.

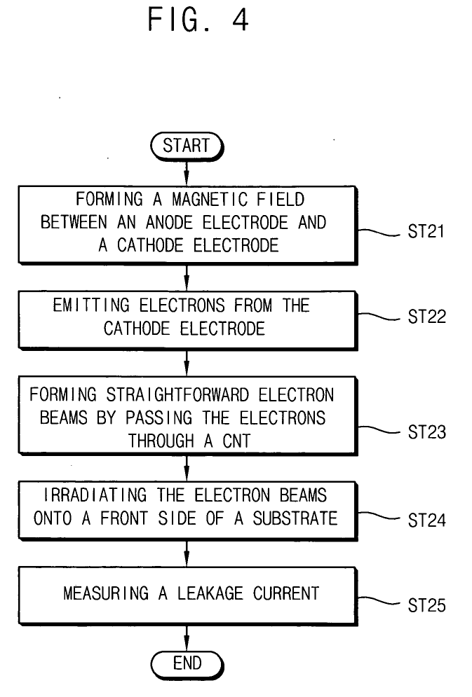

FIG. 4 is a flow diagram of operations that illustrate an inspection method performed by the apparatus of FIG. 3. These operations include establishing a magnetic field between the anode electrode 210 and the cathode electrode 220, using the pair of electromagnets 260 and 270, Block ST21, and emitting electrons from a cathode electrode 220, Block ST22. A wide area and uniformly downward emission of these electrons is then established from an emission surface of the nanotube array 240 by passing these electrons through carbon nanotubes within the array 240, Block ST23. This uniform emission of electrons is irradiated onto an exposed surface of a substrate, Block ST24. This substrate may include a semiconductor wafer having an electrically insulating layer thereon containing a plurality of contact holes. These contact holes may include some contact holes that are at least partially filled with insulating residues that block passage of electrons therethrough. As illustrated by Block ST25, a leakage current from the underside surface of the wafer is measured with an ammeter to identify the presence of blocked contact holes.

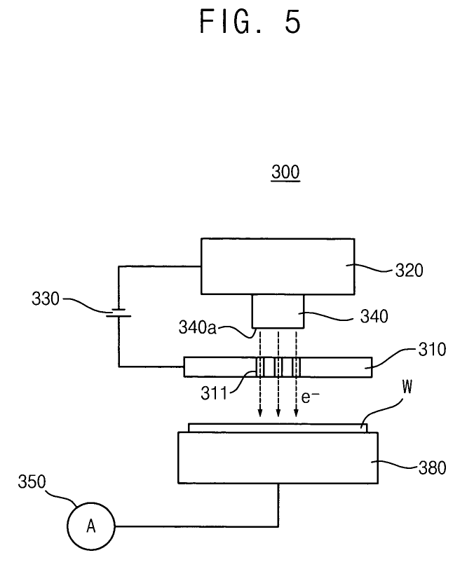

FIG. 5 illustrates an electron-beam inspection tool 300 according to a third embodiment of the invention. This tool 300 includes an anode electrode 310 and a cathode electrode 320, which are powered by a power source 330. This power source 330 establishes a sufficient voltage between the anode electrode 310 and cathode electrode 320 to thereby promote electron emission in a downward direction from the cathode electrode 320 to the anode electrode 310. The anode electrode 310 has a primary surface (e.g., upper surface) and an array of emission holes 311 therein that support passage of electrons (e−) emitted by the cathode electrode 320. A stage 380 is also provided. This stage 380 is configured to support a substrate. This substrate may include a semiconductor wafer (W) having an electrically insulating layer (not shown) thereon. This electrically insulating layer may have a plurality of contact holes therein that expose underlying portions of the semiconductor wafer (W). These contact holes can be inspected for the presence of residues by evaluating the magnitude of leakage current passing from a backside of the wafer (W) to the stage 380. This leakage current may be measured by an ammeter 350, which is electrically coupled to the stage 380.

The inspection tool 300 also includes a clustered nanotube array 340, which is mounted to an emission surface of the cathode electrode 320. The clustered nanotube array 340 has a wide area emission surface 340a thereon, which extends opposite a primary surface of the anode electrode 310. This emission surface 340a is filled with a high density of closely-spaced nanotube openings. The clustered nanotube array 340 is configured so that nanotubes therein provide conductive channels for electrons (e−), which under the influence of an electric field pass from the cathode electrode 320 to the emission holes 311 in the anode electrode 310 via the emission surface 340a. The clustered nanotube array 340 may be a carbon nanotube array having carbon nanotubes therein.

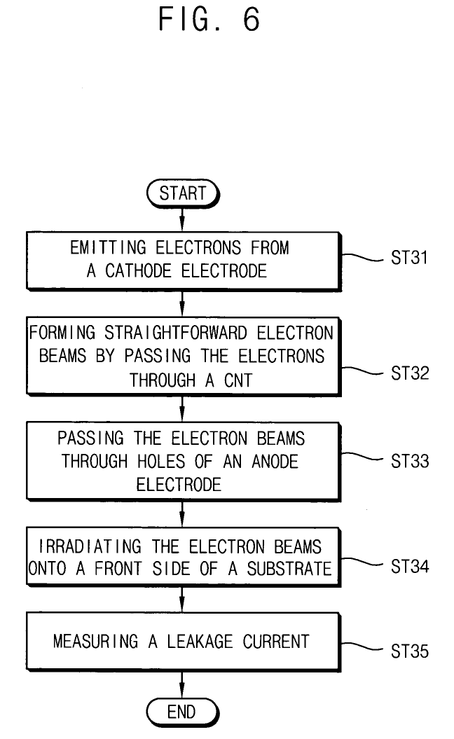

FIG. 6 is a flow diagram of operations that illustrate an inspection method performed by the apparatus of FIG. 5. These operations include emitting electrons from a cathode electrode 320, Block ST31, and forming a wide area and uniformly downward emission of these electrons from an emission surface of the nanotube array 340 by passing these electrons through carbon nanotubes within the array 340, Block ST32. This uniform emission of electrons is irradiated through emission holes 311 in an anode electrode 310, Block ST33, and then onto a front side of a substrate (e.g., wafer W), Block ST34. This substrate may include a semiconductor wafer W having an electrically insulating layer thereon containing a plurality of contact holes. These contact holes may include some contact holes that are at least partially filled with insulating residues that block passage of electrons therethrough. As illustrated by Block ST35, a leakage current from the underside surface of the wafer is measured with an ammeter to identify the presence of blocked contact holes.

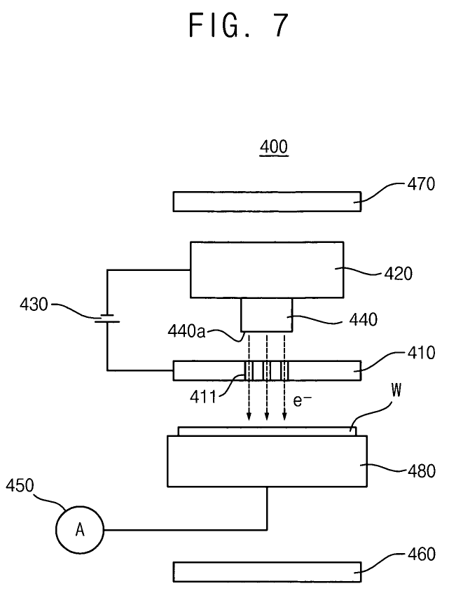

FIG. 7 illustrates an electron-beam inspection tool 400 according to a fourth embodiment of the invention. This tool 400 includes an anode electrode 410 and a cathode electrode 420, which are powered by a power source 430. This power source 430 establishes a sufficient voltage between the anode electrode 410 and cathode electrode 420 to thereby promote electron emission in a downward direction from the cathode electrode 420 to the anode electrode 410. The tool 400 also includes a pair of electromagnets 460 and 470 that operate together to establish a magnetic field in a space between the anode and cathode electrodes. This magnetic field has flux lines that extend vertically between the electromagnets 460 and 470. The anode electrode 410 has a primary surface (e.g., upper surface) and an array of emission holes 411 therein that support passage of electrons (e−) emitted by the cathode electrode 420. A stage 480 is also provided. This stage 480 is configured to support a substrate. This substrate may include a semiconductor wafer (W) having an electrically insulating layer (not shown) thereon. This electrically insulating layer may have a plurality of contact holes therein that expose underlying portions of the semiconductor wafer (W). These contact holes can be inspected for the presence of residues by evaluating the magnitude of leakage current passing from a backside of the wafer (W) to the stage 480. This leakage current may be measured by an ammeter 450, which is electrically coupled to the stage 480.

The inspection tool 400 also includes a clustered nanotube array 440, which is mounted to an emission surface of the cathode electrode 420. The clustered nanotube array 440 has a wide area emission surface 440a thereon, which extends opposite a primary surface of the anode electrode 410 and orthogonal to the magnetic flux lines. This emission surface 440a is filled with a high density of closely-spaced nanotube openings. The clustered nanotube array 440 is configured so that nanotubes therein provide conductive channels for electrons (e−), which under the influence of an electric field pass from the cathode electrode 420 to the emission holes 411 in the anode electrode 410 via the emission surface 440a. The clustered nanotube array 440 may be a carbon nanotube array having carbon nanotubes therein.

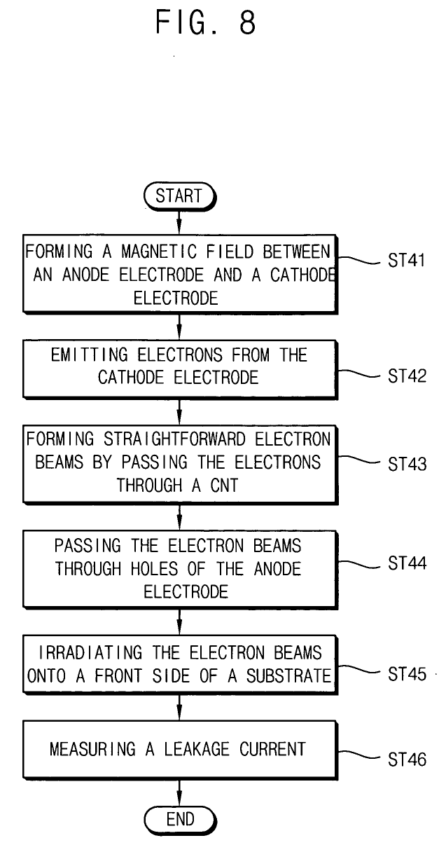

FIG. 8 is a flow diagram of operations that illustrate an inspection method performed by the apparatus of FIG. 7. These operations include establishing a magnetic field between anode and cathode electrodes, ST41, and emitting electrons from the cathode electrode 420, Block ST42. A wide area and uniformly downward emission of these electrons is also established from an emission surface of the nanotube array 440. This emission occurs by passing these electrons through carbon nanotubes within the array 340, Block ST43. This uniform emission of electrons is irradiated through emission holes 411 in an anode electrode 410, Block ST44, and then onto a front side of a substrate (e.g., wafer W), Block ST45. This substrate may include a semiconductor wafer W having an electrically insulating layer thereon containing a plurality of contact holes. These contact holes may include some contact holes that are at least partially filled with insulating residues that block passage of electrons therethrough. As illustrated by Block ST46, a leakage current from the underside surface of the wafer is measured with an ammeter to identify the presence of blocked contact holes.

In the drawings and specification, there have been disclosed typical preferred embodiments of the invention and, although specific terms are employed, they are used in a generic and descriptive sense only and not for purposes of limitation, the scope of the invention being set forth in the following claims.

1. An electron-beam generator, comprising:
anode and cathode electrodes disposed in spaced-apart and opposing relationship relative to each other; and
a clustered nanotube array extending between said anode and cathode electrodes and having an emission surface thereon extending opposite a primary surface of the anode electrode, the clustered nanotube array configured so that nanotubes therein provide conductive channels for electrons passing from the cathode electrode to the anode electrode via the emission surface.

2. The generator of claim 1, wherein the clustered nanotube array comprises carbon nanotubes.

3. The generator of claim 2, further comprising an electromagnetic field generator configured to establish an electromagnetic field in a space between the anode and cathode electrodes.

4. The generator of claim 1, further comprising an electromagnetic field generator configured to establish an electromagnetic field in a space between the anode and cathode electrodes.

5. An electron-beam generator, comprising:
anode electrode; and
an electron emission source disposed in spaced-apart and opposing relationship relative to the anode electrode, the electron emission source comprising a cathode electrode and a clustered nanotube array mounted to the cathode electrode, the clustered nanotube array having an emission surface thereon extending opposite a primary surface of the anode electrode and configured so that carbon nanotubes therein provide conductive channels for electrons passing from the cathode electrode to the anode electrode via the emission surface.

6. The generator of claim 5, further comprising a power source electrically coupled to the anode and cathode electrodes.

7. The generator of claim 6, further comprising an electromagnetic field generator configured to establish an electromagnetic field in a space between the anode and clustered nanotube array.

8. The generator of claim 5, further comprising an electromagnetic field generator configured to establish an electromagnetic field in a space between the anode and clustered nanotube array.

9. An electron-beam inspection tool, comprising:
anode and cathode electrodes disposed in spaced-apart and opposing relationship relative to each other, the anode electrode having a primary surface thereon configured to receive a semiconductor wafer;
a clustered nanotube array extending between the anode and cathode electrodes and having an emission surface thereon extending opposite the primary surface of the anode electrode, the clustered nanotube array configured so that nanotubes therein provide conductive channels for electrons passing from the cathode electrode to the anode electrode via the emission surface;
a power source electrically coupled to the anode and cathode electrodes; and
an ammeter electrically coupled to the anode electrode and configured to measure leakage current passing from the semiconductor wafer to the primary surface of the anode electrode.

10. The electron-beam inspection tool of claim 9, wherein the clustered nanotube array comprises carbon nanotubes.

11. The electron-beam inspection tool of claim 10, further comprising an electromagnetic field generator configured to establish an electromagnetic field in a space between the anode and cathode electrodes.

12. The electron-beam inspection tool of claim 9, further comprising an electromagnetic field generator configured to establish an electromagnetic field in a space between the anode and cathode electrodes.

13. An electron-beam inspection tool, comprising:
anode and cathode electrodes disposed in spaced-apart and opposing relationship relative to each other, the anode electrode having a primary surface thereon and an array of emission holes therein;
a clustered nanotube array extending between the anode and cathode electrodes and having an emission surface thereon extending opposite the primary surface of the anode electrode, the clustered nanotube array configured so that nanotubes therein provide conductive channels for electrons passing from the cathode electrode to the anode electrode via the emission surface;
a power source electrically coupled to the anode and cathode electrodes;
a stage adapted to receive a semiconductor wafer on a primary surface thereof; and
an ammeter electrically coupled to the stage and configured to measure leakage current passing from the semiconductor wafer to the primary surface of the stage.

14. The electron-beam inspection tool of claim 13, wherein the anode electrode is disposed between the stage and the cathode electrode.

15. The electron-beam inspection tool of claim 13, further comprising an electromagnetic field generator configured to establish an electromagnetic field in a space between the anode and cathode electrodes.

16. The electron-beam inspection tool of claim 13, wherein the clustered nanotube array comprises carbon nanotubes.

17. A method of inspecting a semiconductor substrate, comprising the step of:
emitting beams of electrons from an emission surface of a clustered carbon nanotube array to a semiconductor substrate having a plurality of contact holes thereon.

18. The method of claim 17, wherein the semiconductor substrate comprises a semiconductor wafer and an electrically insulating layer on the semiconductor wafer, the electrically insulating layer having the plurality of contact holes therein that expose corresponding portions of the semiconductor wafer.

19. The method of claim 17, wherein the emitting step is performed in a presence of an electromagnetic field.

20. The method of claim 17, wherein the emitting step is performed in a presence of an electromagnetic field having flux lines extending in a substantially orthogonal direction relative to the emission surface.
